(19) United States
(12) Patent Application Publication
(10) Pub. No.: US 2017/0193632 A1
(43) Pub. Date: Jul. 6, 2017

(54) MEDIA FILE PROCESSING METHOD AND APPARATUS

(71) Applicant: Huawei Technologies Co., Ltd., Shenzhen, Guangdong (CN)

(72) Inventor: Lei Chen, Beijing (CN)

(21) Appl. No.: 15/313,866

(22) PCT Filed: May 27, 2014
(86) PCT No.: PCT/CN2014/078502

§ 371 Date: Nov. 23, 2016

(51) Int. Cl. G06T 3/20; G06F 3/0484

(52) U.S. Cl. CPC G06T 3/20; G06F 3/04845

(57) ABSTRACT

Embodiments of the present invention provide a media file processing method and apparatus. The media file processing method in the present invention includes: specifying input event information and identification ID information corresponding to the input event information; decoding data of a preset length in a media file corresponding to the input event information, and storing, in a specified memory, pulse code modulation PCM data obtained by means of decoding and ID information corresponding to the media file; receiving first input event information of a user, and determining first ID information according to the specified input event information and the ID information corresponding to the input event information; and acquiring, from the memory according to the first ID information, first PCM data corresponding to the first ID information, and playing the first PCM data.

### CROSS-REFERENCE TO RELATED APPLICATIONS

This application is a National Stage of International Application No. PCT/CN2014/078502, filed on May 27, 2014, which is hereby incorporated by reference in its entireties.

### TECHNICAL FIELD

Embodiments of the present invention relate to communications technologies, and in particular, to a media file processing method and apparatus.

### BACKGROUND

With advancement of science and technology, all intelligent devices such as smartphones have a capability of playing a media file. In the prior art, after receiving an input event of a user, an intelligent device acquires, at an application layer according to the input event, a media file that needs to be played, decodes the media file at an intermediate layer, and then plays Pulse Code Modulation (Pulse Code Modulation, PCM for short) data obtained by means of the decoding. Because a decoding process requires a relatively long time, an existing process of playing a media file is time-consuming, causing a long delay.

### SUMMARY

Embodiments of the present invention provide a media file processing method and apparatus, so as to improve playing efficiency of an intelligent device.

According to a first aspect, an embodiment of the present invention provides a media file processing method, including:

specifying input event information and identification ID information corresponding to the input event information;

decoding data of a preset length in a media file corresponding to the input event information, and storing, in a specified memory, pulse code modulation PCM data obtained by means of decoding and ID information corresponding to the media file, where the ID information corresponding to the media file is consistent with the ID information corresponding to the input event information;

receiving first input event information of a user, and determining first ID information according to the specified input event information and the ID information corresponding to the input event information, where the first input event information is any piece of information in the specified input event information, and the first ID information is ID information that corresponds to the first input event information and that is in the ID information corresponding to the specified input event information; and

acquiring, from the memory according to the first ID information, first PCM data corresponding to the first ID information, and playing the first PCM data, where the first PCM data is PCM data obtained after the data of the preset length in the media file corresponding to the first input event information is decoded.

With reference to the first aspect, in a first possible implementation manner of the first aspect, the decoding data of a preset length in a media file corresponding to the input event info Ration, and storing, in a specified memory, PCM data obtained by means of decoding and ID information corresponding to the media file includes:

decoding the data of the preset length in the media file corresponding to the input event information, and storing, in a first memory, the PCM data obtained by means of decoding and the ID information corresponding to the media file.

With reference to the first possible implementation manner of the first aspect, in a second possible implementation manner of the first aspect, the acquiring, from the memory according to the first ID information, first PCM data corresponding to the first ID information, and playing the first PCM data includes:

acquiring, according to the first ID information, the first PCM data from the first memory, and playing the first PCM data.

With reference to the first aspect, in a third possible implementation manner of the first aspect, the decoding data of a preset length in a media file corresponding to the input event information, and storing, in a specified memory, PCM data obtained by means of decoding and ID information corresponding to the media file includes:

decoding a first data segment of a preset length of the media file corresponding to the input event information, and storing, in a second memory, a first PCM data segment obtained by means of decoding and the ID information corresponding to the media file; and

decoding a second data segment of a preset length of the media file corresponding to the input event information, and storing, in a third memory, a second PCM data segment obtained by means of decoding and the ID information corresponding to the media file, where the first data segment of the preset length and the second data segment of the preset length are continuous in terms of a time sequence, the first PCM data segment is a first data segment of the first PCM data, and the second PCM data segment is a second data segment that is continuous with the first PCM data segment in terms of time and that is in the first PCM data.

With reference to the third possible implementation manner of the first aspect, in a fourth possible implementation manner of the first aspect, the acquiring, from the memory according to the first ID information, first PCM data corresponding to the first ID information, and playing the first PCM data includes:

acquiring, according to the first ID information, the first PCM data segment from the second memory;

acquiring, according to the first ID information, the second PCM data segment from the third memory;

playing the first PCM data segment; and

playing the second PCM data segment.

With reference to the fourth possible implementation manner of the first aspect, in a fifth possible implementation manner of the first aspect, after the playing the first PCM data segment, the method further includes:

decoding a third data segment of a preset length of the media file corresponding to the input event information, and storing, in the second memory, a third PCM data segment obtained by means of decoding and the ID information corresponding to the media file, where the second data segment of the preset length and the third data segment of the preset length are continuous in terms of a time sequence, and the third PCM data segment is a third data segment that is continuous with the second PCM data segment in terms of time and that is in the first PCM data; and

acquiring, according to the first ID information, the third PCM data segment from the second memory.

With reference to the fifth possible implementation manner of the first aspect, in a sixth possible implementation manner of the first aspect, after the playing the second PCM data segment, the method further includes:

decoding a fourth data segment of a preset length of the media file corresponding to the input event information, and storing, in the third memory, a fourth PCM data segment obtained by means of decoding and the ID information corresponding to the media file, where the third data segment of the preset length and the fourth data segment of the preset length are continuous in terms of a time sequence, and the fourth PCM data segment is a fourth data segment that is continuous with the third PCM data segment in terms of time and that is in the first PCM data; and

acquiring, according to the first ID information, the fourth PCM data segment from the third memory.

According to a second aspect, an embodiment of the present invention provides a media file processing method, including:

receiving an input event of a user;

determining, according to the input event, a drawing area that is of a first image and that exceeds a display range, and drawing the first image;

determining distance information of image translation according to the input event; and

capturing, from the first image according to the distance information, image content that needs to be displayed and that corresponds to the input event, and displaying the image content that needs to be displayed.

With reference to the second aspect, in a first possible implementation manner of the second aspect, the determining, according to the input event, a drawing area that is of a first image and that exceeds a display range includes:

determining, according to coordinate information of the input event, the drawing area that is of the first image and that exceeds the display range.

With reference to the second aspect, in a second possible implementation manner of the second aspect, the determining, according to the input event, a drawing area that is of a first image and that exceeds a display range further includes:

determining, according to coordinate information and rate information that are of the input event, the drawing area that is of the first image and that exceeds the display range.

With reference to the first aspect and either of the first to the second possible implementation manners of the first aspect, in a third possible implementation manner of the second aspect, the drawing the first image includes:

acquiring an image resource required for drawing the first image; and

drawing the first image according to the image resource and the drawing area of the first image.

With reference to the second aspect and any one of the first to the third possible implementation manners of the second aspect, in a fourth possible implementation manner of the second aspect, the determining distance information of image translation according to the input event includes:

obtaining coordinate displacement information of the input event according to start coordinates and termination coordinates of the input event; and

determining the distance information of the image translation according to the coordinate displacement information.

With reference to the first aspect and any one of the first to the fourth possible implementation manners of the first aspect, in a fifth possible implementation manner of the second aspect, before the determining, according to the input event, a drawing area that is of a first image and that exceeds a display range, the method further includes:

acquiring the coordinate information of the input event.

According to a third aspect, an embodiment of the present invention provides a media file processing apparatus, including:

a specifying module, configured to specify input event information and identification ID information corresponding to the input event information;

a decoding module, configured to decode data of a preset length in a media file corresponding to the input event information, and store, in a specified memory, pulse code modulation PCM data obtained by means of decoding and ID information corresponding to the media file, where the ID information corresponding to the media file is consistent with the ID information corresponding to the input event information;

a receiving module, configured to receive first input event information of a user, and determine first ID information according to the specified input event information and the ID information corresponding to the input event information, where the first input event information is any piece of information in the specified input event information, and the first ID information is ID information that corresponds to the first input event information and that is in the ID information corresponding to the specified input event information; and

a playing module, configured to acquire, from the memory according to the first ID information, first PCM data corresponding to the first ID information, and play the first PCM data, where the first PCM data is PCM data obtained after the data of the preset length in the media file corresponding to the first input event information is decoded.

With reference to the third aspect, in a first possible implementation manner of the third aspect, the decoding module is specifically configured to: decode the data of the preset length in the media file corresponding to the input event information, and store, in a first memory, the PCM data obtained by means of decoding and the ID information corresponding to the media file.

With reference to the first possible implementation manner of the third aspect, in a second possible implementation manner of the third aspect, the playing module is specifically configured to: acquire, according to the first ID information, the first PCM data from the first memory, and play the first PCM data.

With reference to the third aspect, in a third possible implementation manner of the third aspect, the decoding module includes:

a first decoding unit, configured to decode a first data segment of a preset length of the media file corresponding to the input event information, and store, in a second memory, a first PCM data segment obtained by means of decoding and the ID information corresponding to the media file; and

a second decoding unit, configured to decode a second data segment of a preset length of the media file corresponding to the input event information, and store, in a third memory, a second PCM data segment obtained by means of decoding and the ID information corresponding to the media file, where the first data segment of the preset length and the second data segment of the preset length are continuous in terms of a time sequence, the first PCM data segment is a first data segment of the first PCM data, and the second PCM data segment is a second data segment that is continuous with the first PCM data segment in terms of time and that is in the first PCM data.

With reference to the third possible implementation manner of the third aspect, in a fourth possible implementation manner of the third aspect, the playing module includes:

a first acquiring unit, configured to acquire, according to the first ID information, the first PCM data segment from the second memory;

a second acquiring unit, configured to acquire, according to the first ID information, the second PCM data segment from the third memory;

a first playing unit, configured to play the first PCM data segment; and

a second playing unit, configured to play the second PCM data segment.

With reference to the fourth possible implementation manner of the third aspect, in a fifth possible implementation manner of the third aspect, the first decoding unit is further configured to: decode a third data segment of a preset length of the media file corresponding to the input event information, and store, in the second memory, a third PCM data segment obtained by means of decoding and the ID information corresponding to the media file, where the second data segment of the preset length and the third data segment of the preset length are continuous in terms of a time sequence, and the third PCM data segment is a third data segment that is continuous with the second PCM data segment in terms of time and that is in the first PCM data; and

the first acquiring unit is further configured to acquire, according to the first ID information, the third PCM data segment from the second memory.

With reference to the fifth possible implementation manner of the third aspect, in a sixth possible implementation manner of the third aspect, the second decoding unit is further configured to: decode a fourth data segment of a preset length of the media file corresponding to the input event information, and store, in the third memory, a fourth PCM data segment obtained by means of decoding and the ID information corresponding to the media file, where the third data segment of the preset length and the fourth data segment of the preset length are continuous in terms of a time sequence, and the fourth PCM data segment is a fourth data segment that is continuous with the third PCM data segment in terms of time and that is in the first PCM data; and

the second acquiring unit is further configured to acquire, according to the first ID information, the fourth PCM data segment from the third memory.

According to a fourth aspect, an embodiment of the present invention provides a media file processing apparatus, including:

a receiving module, configured to receive an input event of a user;

a drawing module, configured to determine, according to the input event, a drawing area that is of a first image and that exceeds a display range, and draw the first image;

a determining module, configured to determine distance information of image translation according to the input event; and

a display module, configured to capture, from the first image according to the distance information, image content that needs to be displayed and that corresponds to the input event, and display the image content that needs to be displayed.

With reference to the fourth aspect, in a first possible implementation manner of the fourth aspect, the drawing module is specifically configured to determine, according to coordinate information of the input event, the drawing area that is of the first image and that exceeds the display range.

With reference to the fourth aspect, in a second possible implementation manner of the fourth aspect, the drawing module is specifically configured to determine, according to coordinate information and rate information that are of the input event, the drawing area that is of the first image and that exceeds the display range.

With reference to the fourth aspect and either of the first to the second possible implementation manners of the fourth aspect, in a third possible implementation manner of the second aspect, the drawing module is specifically configured to: acquire an image resource required for drawing the first image; and draw the first image according to the image resource and the drawing area of the first image.

With reference to the fourth aspect and any one of the first to the third possible implementation manners of the fourth aspect, in a fourth possible implementation manner of the second aspect, the determining module is specifically configured to: obtain coordinate displacement information of the input event according to start coordinates and termination coordinates of the input event; and determine the distance information of the image translation according to the coordinate displacement information.

With reference to the fourth aspect and any one of the first to the fourth possible implementation manners of the fourth aspect, in a fifth possible implementation manner of the second aspect, the apparatus further includes:

an acquiring module, configured to acquire the coordinate info illation of the input event.

In the present invention, first, input event information and ID information corresponding to the input event information are specified; data of a preset length in a media file corresponding to the input event information is decoded, and pulse code modulation PCM data obtained by means of decoding and ID information corresponding to the media file are stored in a specified memory, where the ID information corresponding to the media file is consistent with the ID information corresponding to the input event information; first input event information of a user is received, and first ID information is determined according to the specified input event information and the ID information corresponding to the input event information, so that first PCM data corresponding to the first ID information is acquired from the memory according to the first ID information, and the first PCM data is played. Therefore, interval time from user input to media file playing is dramatically shortened and playing efficiency of an intelligent device is improved.

### BRIEF DESCRIPTION OF THE DRAWINGS

To describe the technical solutions in the embodiments of the present invention or in the prior art more clearly, the following briefly introduces the accompanying drawings required for describing the embodiments or the prior art. Apparently, the accompanying drawings in the following description show some embodiments of the present invention, and persons of ordinary skill in the art may still derive other drawings from these accompanying drawings without creative efforts.

FIG. 1 is a schematic diagram of a platform architecture of an intelligent device;

FIG. 2 is a schematic flowchart of Embodiment 1 of a media file processing method according to the present invention;

FIG. 3 is a schematic flowchart of Embodiment 2 of a media file processing method according to the present invention;

FIG. 4 is a schematic flowchart of Embodiment 3 of a media file processing method according to the present invention;

FIG. 5 is a schematic flowchart of Embodiment 4 of a media file processing method according to the present invention;

FIG. 6 is a schematic flowchart of Embodiment 5 of a media file processing method according to the present invention;

FIG. 7 is a diagram of a current interface in Embodiment 5 of a media file processing method according to the present invention;

FIG. 8 is a diagram of a first image in Embodiment 5 of a media file processing method according to the present invention;

FIG. 9 is a diagram of a finally displayed image in Embodiment 5 of a media file processing method according to the present invention;

FIG. 10 is a schematic structural diagram of Embodiment 1 of a media file processing apparatus according to the present invention;

FIG. 11 is a schematic structural diagram of Embodiment 1 of an intelligent device according to the present invention;

FIG. 12 is a schematic structural diagram of Embodiment 2 of a media file processing apparatus according to the present invention; and

FIG. 13 is a schematic structural diagram of Embodiment 2 of an intelligent device according to the present invention.

### DETAILED DESCRIPTION

To make the objectives, technical solutions, and advantages of the embodiments of the present invention clearer, the following clearly and completely describes the technical solutions in the embodiments of the present invention with reference to the accompanying drawings in the embodiments of the present invention. Apparently, the described embodiments are some but not all of the embodiments of the present invention. All other embodiments obtained by persons of ordinary skill in the art based on the embodiments of the present invention without creative efforts shall fall within the protection scope of the present invention.

FIG. 1 is a schematic diagram of a platform architecture of an intelligent device. As shown in FIG. 1, the platform architecture of the intelligent device provided in this embodiment includes an application layer, a intermediate layer, and a driver layer. The application layer includes multiple core application programs, and management and service components; the intermediate layer includes a database component, program library and operating system run-time components and virtual machines, and the intermediate layer is a bridge between the driver layer and the application layer; and the driver layer includes a system core and a driver component.

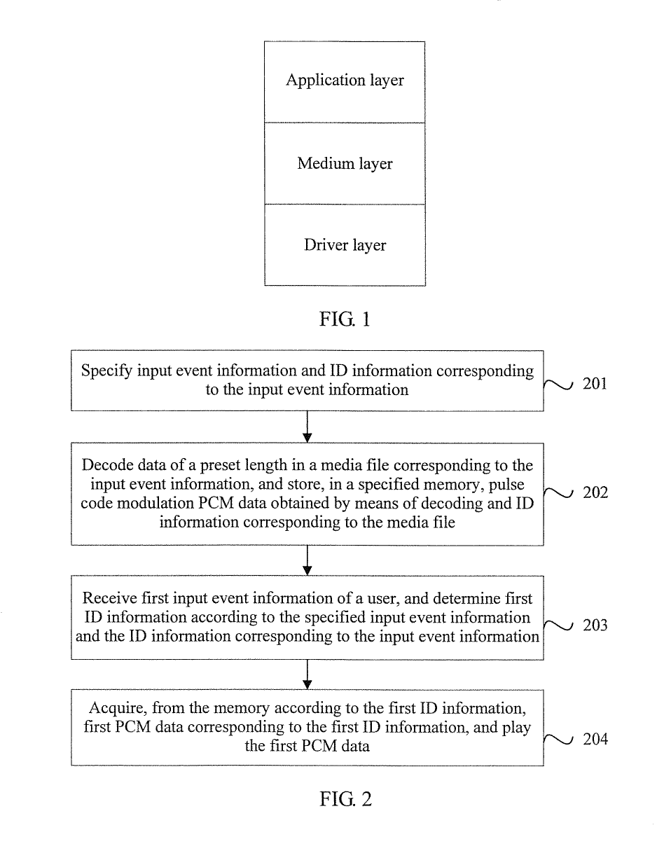

FIG. 2 is a schematic flowchart of Embodiment 1 of a media file processing method according to the present invention. As shown in FIG. 2, the method in this embodiment may include the following steps:

Step 201: Specify input event information and identification ID information corresponding to the input event information.

Step 202: Decode data of a preset length in a media file corresponding to the input event information, and store, in a specified memory, pulse code modulation PCM data obtained by means of decoding and ID information corresponding to the media file.

The ID information corresponding to the media file is consistent with the ID information corresponding to the input event information.

Step 203: Receive first input event information of a user, and determine first ID information according to the specified input event information and the ID information corresponding to the input event information, where the first input event information is any piece of information in the specified input event information, and the first ID information is ID information that corresponds to the first input event information and that is in the ID information corresponding to the specified input event information.

Step 204: Acquire, from the memory according to the first ID information, first PCM data corresponding to the first ID information, and play the first PCM data.

The first PCM data is PCM data obtained after the data of the preset length in the media file corresponding to the first input event information is decoded.

An application scenario of this embodiment may be shown in FIG. 1. Details are not described again in this embodiment. This embodiment may be executed by an intelligent device, where the intelligent device integrates a media file processing apparatus, and the intelligent device includes but is not limited to devices such as a smartphone and a tablet computer. In a specific implementation process, when or before an application program is started, the intelligent device specifies, at an application layer, all possible input event information and identification (Identification, ID for short) information corresponding to each piece of input event information in the application program, decodes data of a preset length in a media file corresponding to each piece of input event information, and stores, in a specified memory, PCM data obtained by means of decoding and ID information corresponding to the media file, where the ID information corresponding to the media file is consistent with the ID information corresponding to the input event information, that is, the intelligent device establishes, at the application layer, a matching relationship between each input event and a corresponding media file by using the ID information. That is, one piece of input event information corresponds to a unique piece of ID information and a corresponding media file.

In the prior art, a correspondence between a specific input event and a media file is known to the application layer of the intelligent device, but is unknown to a intermediate layer and a driver layer. Therefore, when receiving an input event, the intelligent device needs to send input event information to the intermediate layer, and the intelligent device further forwards, at the intermediate layer, the input event information to the application layer, so that the intelligent device completes, at the application layer, matching between the input event and a media file. In contrast, in this embodiment, the intelligent device may notify, at the application layer, the intermediate layer or the driver layer of the intelligent device of the input event information, the media file corresponding to the input event information, and matching information of the ID information corresponding to the input event information (the media file) in advance, so that the intelligent device completes, at the intermediate layer or the driver layer, an operation of matching between the input event and the media file. In this embodiment, an example in which the intelligent device notifies, at the application layer, the driver layer of the intelligent device of the matching information is used to describe the embodiment of the media file processing method in the present invention in detail.

Specifically, in this embodiment, the intelligent device may notify, at the application layer, the driver layer of the intelligent device of each piece of input event information and corresponding ID information by invoking an input event specifying interface added to the intermediate layer. Optionally, the input event specifying interface may be defined as follows:

“register_audio_input_event (Num, event_type, event_info, ID)”, where

Num: a quantity of input events, for example, a quantity of keys that need to be matched with sound playing, or a quantity of touch areas on a screen that require corresponding sound responses;

event_type: a type of an input event, such as a key, a touchscreen, a proximity sensing, and a gravity sensing;

event_info: specific input event information, such as a key value of a key, a range of a specified area on a touchscreen, a distance threshold for the proximity sensing, posture identification for the gravity sensor; and

ID: specified ID information corresponding to an input event.

In addition, in the prior art, after completing, at the application layer, the matching between the input event and the media file, the intelligent device acquires, according to the input event information, a media file that needs to be played. Further, the intelligent device decodes the media file at the intermediate layer, and transfers PCM data obtained by means of decoding to the driver layer. Further, the intelligent device configures, at the driver layer, parameters for a device used to play the media file, and sends the received PCM data to the device used to play the PCM data, so as to complete a process of playing the media file. Therefore, a delay is relatively long in the prior art. In contrast, in this embodiment, the intelligent device decodes the data of the preset length in the media file corresponding to each piece of input event information in advance, and stores, in the specified memory (each memory stores one piece of ID information and PCM data corresponding to the ID information), each piece of PCM data obtained by means of decoding and ID information corresponding to each media file (a media file corresponding to the PCM data) without a need to occupy time spent in the process of playing the media file. Specifically, in this embodiment, the intelligent device may invoke, at the application layer, a media file pre-playing interface added to the intermediate layer, so that the intelligent device may use, at the intermediate layer, software or hardware such as DSP to decode data of a preset length in all media files that may be played in an application interface of the application program, and stores, in the specified memory, the PCM data obtained by means of decoding and the ID information corresponding to the media files, so as to make preparations before the media files are played.

Optionally, the media file pre-playing interface may be defined as follows:

“Prepare_play_media_files (Num,media_file, ID)”, where

Num: a quantity of media files to be pre-played;

media_file: a corresponding media file; and

ID: ID information that corresponds to a media file and that is consistent with ID information corresponding to an input event, where the input event corresponds to the media file.

Optionally, step 202 may include: decoding the data of the preset length in the media file corresponding to the input event information, and storing, in a first memory, the PCM data obtained by means of decoding and the ID information corresponding to the media file.

In this embodiment, the intelligent device may invoke, at the application layer, a media file pre-playing interface added to the intermediate layer, so that the intelligent device decodes, at the intermediate layer, data of a preset length in a media file corresponding to one piece of input event information in an application interface of the application program, and store, at the driver layer and in the first memory, the PCM data obtained by means of decoding and the ID infatuation corresponding to the media file (when the intelligent device notifies, at the application layer, the intermediate layer of the intelligent device of the matching information, the intelligent device stores, at the intermediate layer and in the first memory, the PCM data obtained by means of decoding and the ID information corresponding to the media file). Optionally, when there are multiple media files that need to be played, according to the foregoing decoding and storing steps, the intelligent device separately decodes the media file corresponding to each piece of input event information and stores the decoded media file in the corresponding first memory (that is, each piece of input event information corresponds to one first memory). For example, in an application of playing the piano, each input event corresponds to one media file with relatively short time. When or before the application is started, the intelligent device may specify all possible input event information and ID information corresponding to the input event information in the application of playing the piano, separately decode a media file corresponding to each piece of input event information, and separately store, in a corresponding memory, each piece of PCM data obtained by means of decoding and the ID information corresponding to each piece of input event information.

In step 203, the intelligent device receives the first input event information of the user, such as key pressing or touchscreen tapping. Optionally, the receiving first input event information of a user is implemented in an interrupt receiving manner. Further, at the driver layer, the intelligent device determines the interrupt type and acquires the first input event information. In this embodiment of the present invention, optionally, the intelligent device directly performs, at the driver layer, matching between the first input event information and the specified input event information and the ID information corresponding to the input event information (when the intelligent device notifies, at the application layer, the intermediate layer of the intelligent device of the matching information, the intelligent device can also directly perform, at the intermediate layer, the matching between the first input event information and the specified input event information and the ID information corresponding to the input event information), so as to determine the first ID information corresponding to the first input event information. The first input event information is any piece of information in the specified input event information, and the first ID information is the ID information that corresponds to the first input event information and that is in the ID information corresponding to the specified input event information.

In step 204, optionally, the first PCM data is acquired from the first memory according to the first ID information, and the first PCM data is played. In this embodiment of the present invention, the intelligent device directly acquires, at the driver layer and from the first memory according to the first ID information, the first PCM data corresponding to the first ID information, where the first PCM data is the PCM data obtained after the data of the preset length in the media file corresponding to the first input event information is decoded. Optionally, when there are multiple media files that need to be played, the intelligent device directly acquires, at the driver layer according to the first ID information, the first PCM data from the first memory corresponding to the first ID information (that is, each piece of ID information corresponds to one first memory).

Further, at the driver layer, the intelligent device completes initialization of an audio device and configures parameters for sound playing (such as volume and filter configuration), so as to send the first PCM data to the audio device for playing.

Optionally, step 202 may further include: decoding a first data segment of a preset length of the media file corresponding to the input event information, and storing, in a second memory, a first PCM data segment obtained by means of decoding and the ID information corresponding to the media file; and

decoding a second data segment of a preset length of the media file corresponding to the input event information, and storing, in a third memory, a second PCM data segment obtained by means of decoding and the ID information corresponding to the media file, where the first data segment of the preset length and the second data segment of the preset length are continuous in terms of a time sequence, the first PCM data segment is a first data segment of the first PCM data, and the second PCM data segment is a second data segment that is continuous with the first PCM data segment in terms of time and that is in the first PCM data.

In this embodiment, the intelligent device may invoke, at the application layer, a media file pre-playing interface added to the intermediate layer, so that the intelligent device decodes, at the intermediate layer, a first data segment of a preset length of a media file (such as a first 1000 ms of the media file) corresponding to one piece of input event information in an application interface of the application program, and stores, in the second memory, the first PCM data segment obtained by means of decoding and the ID information corresponding to the media file; decodes a second data segment of a preset length of the media file (such as a second 1000 ms of the media file) corresponding to the input event information, and stores, in a third memory, the second PCM data segment obtained by means of decoding and the ID information corresponding to the media file, where the first data segment of the preset length and the second data segment of the preset length are continuous in terms of a time sequence, the first PCM data segment is a first data segment of the first PCM data, and the second PCM data segment is a second data segment that is continuous with the first PCM data segment in terms of time and that is in the first PCM data, that is, two memories with a specified length are allocated to each corresponding ID, where the memories may store audio PCM data with a specified length.

In step 203, the intelligent device receives the first input event information of the user, and directly performs, at the driver layer, the matching between the first input event information and the specified input event information and the ID information corresponding to the input event information, so as to determine the first ID information corresponding to the first input event information. The first input event information is any piece of information in the specified input event information, and the first ID information is the ID information that corresponds to the first input event information and that is in the ID information corresponding to the specified input event information.

In step 204, optionally, the first PCM data segment is acquired from the second memory according to the first ID information; the second PCM data segment is acquired from the third memory according to the first ID information; the first PCM data segment is played; and the second PCM data segment is played.

In this embodiment of the present invention, the intelligent device directly acquires, at the driver layer and from the second memory according to the first ID information, a first PCM data segment corresponding to the first ID information, and acquires, according to the first ID information, the second PCM data segment from the third memory. Further, after completing initialization of an audio device and configuring parameters for sound playing at the driver layer, the intelligent device sends the first PCM data segment to the audio device for playing, and then plays the second PCM data segment.

Optionally, in this embodiment, if playing of the media file is not complete, after the first PCM data segment is played, the method may further include: decoding a third data segment of a preset length of the media file corresponding to the input event information, and storing, in the second memory, a third PCM data segment obtained by means of decoding and the ID information corresponding to the media file; and acquiring, according to the first ID information, the third PCM data segment from the second memory. The second data segment of the preset length and the third data segment of the preset length are continuous in terms of a time sequence, and the third PCM data segment is a third data segment that is continuous with the second PCM data segment and that is in the first PCM data.

Optionally, after the second PCM data segment is played, the method further includes: decoding a fourth data segment of a preset length of the media file corresponding to the input event information, and storing, in the third memory, a fourth PCM data segment obtained by means of decoding and the ID information corresponding to the media file; and acquiring, according to the first ID information, the fourth PCM data segment from the third memory. The third data segment of the preset length and the fourth data segment of the preset length are continuous in terms of a time sequence, and the fourth PCM data segment is a fourth data segment that is continuous with the third PCM data segment and that is in the first PCM data.

In this embodiment of the present invention, if the playing of the media file is not complete, after playing the first PCM data segment, the intelligent device may report one piece of request information to the application layer of the intelligent device, where the request information includes requesting new PCM data. Therefore, the intelligent device may invoke, at the application layer, the media file pre-playing interface, so as to decode, at the intermediate layer, the third data segment of the preset length of the media file (such as a third 1000 ms of the media file) corresponding to the input event information, and store, in the second memory, the third PCM data segment obtained by means of decoding and the ID information corresponding to the media file, where the third PCM data is a third data segment that is continuous with the second PCM data segment in terms of time and that is in the first PCM data. Optionally, the decoding and storing process may be simultaneously performed with a process of playing the second PCM data segment, so as to ensure that the memory always has decoded first PCM data available for direct playing, without a need to spend other time to perform decoding. In this embodiment, after the second PCM data segment is played, the intelligent device may directly acquire, at the driver layer according to the first ID information, the third PCM data segment from the second memory, so as to play the third PCM data segment.

Further, in this embodiment of the present invention, after playing the second PCM data segment, the intelligent device may report one piece of request information to the application layer of the intelligent device, where the request information includes requesting new PCM data. Therefore, the intelligent device may invoke, at the application layer, the media file pre-playing interface, so as to decode, at the intermediate layer, the fourth data segment of the preset length of the media file (such as a fourth 1000 ms of the media file) corresponding to the input event information, and store, in the third memory, the fourth PCM data segment obtained by means of decoding and the ID information corresponding to the media file, where the fourth PCM data segment is a fourth data segment that is continuous with the third PCM data segment in terms of time and that is in the first PCM data. Optionally, the decoding and storing process may be simultaneously performed with the process of playing the third PCM data segment (that is, audio playing and decoding are synchronously performed). In this embodiment, after the third PCM data segment is played, the intelligent device may directly acquire, at the driver layer according to the first ID information, the fourth PCM data segment from the third memory, so as to play the third PCM data segment. Optionally, if the playing of the media file is not complete, the decoding and storing process is cyclically executed until the playing of the media file is complete.

Optionally, when there are multiple media files that need to be played, according to the foregoing decoding and storing steps, the intelligent device may separately perform corresponding decoding on the media file corresponding to each piece of input event information, and store the decoded media file in a corresponding second memory and a corresponding third memory, that is, each piece of input event information (each piece of ID information) corresponds to one second memory and one third memory. For a specific process, refer to the foregoing embodiment, and details are not described herein again.

Optionally, in this embodiment of the present invention, it is not limited that only two memories with a specified length can be allocated to each corresponding ID. More than two memories with a specified length can also be allocated to each ID. This embodiment of the present invention sets no limitation thereto.

In this embodiment of the present invention, first, input event information and ID information corresponding to the input event information are specified; data of a preset length in a media file corresponding to the input event information is decoded, and pulse code modulation PCM data obtained by means of decoding and ID information corresponding to the media file are stored in a specified memory, where the ID information corresponding to the media file is consistent with the ID infatuation corresponding to the input event information; first input event information of a user is received, first ID information is determined according to the specified input event information and the ID information corresponding to the input event information; so that first PCM data corresponding to the first ID information is acquired from the memory according to the first ID information, and the first PCM data is played. Therefore, interval time from user input to media file playing is dramatically shortened and playing efficiency of an intelligent device is improved.

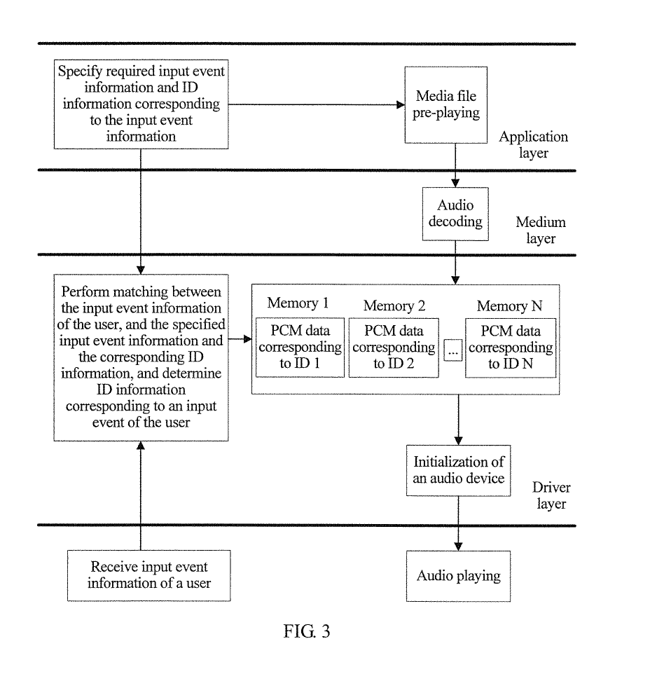

FIG. 3 is a schematic flowchart of Embodiment 2 of a media file processing method according to the present invention. In this embodiment of the present invention, an example of playing the piano is used to describe the media file processing method in detail. As shown in FIG. 3, an intelligent device pre-specifies, at an application layer, all possible input event information (such as various keys) and ID information corresponding to the input event information in an application program of playing the piano, and transfers each piece of specified input event information and ID information corresponding to each piece of input event information to a driver layer before a user inputs an event, so that the intelligent device directly determines, at the driver layer, ID information corresponding to the input event of the user after receiving the input event of the user; in addition, after the intelligent device specifies the required input event information and the ID information corresponding to the input event information, the intelligent device acquires, from a file system, a media file corresponding to each piece of input event information (for example, media files corresponding to fixed sounds of different keys). Optionally, by invoking a media file pre-playing interface added to a intermediate layer, the intelligent device separately performs, at the intermediate layer, audio decoding on the media file corresponding to each piece of input event information. The intelligent device stores, at the driver layer and in a specified memory, each piece of PCM data obtained by decoding the media file corresponding to each piece of input event information and ID information corresponding to each media file (where the ID information corresponding to the input event information is consistent with the ID information corresponding to the media file that corresponds to the input event information). As shown in FIG. 3, a memory 1 stores PCM data corresponding to ID 1, a memory 2 stores PCM data corresponding to ID 2, . . . , and a memory N stores PCM data corresponding to ID N. Further, when the terminal device receives the input event information of a user, the terminal device may directly perform, at the driver layer, matching between the input event information of the user, and each piece of pre-specified input event information and each piece of corresponding ID information (the input event information of the user is any piece of event information in each piece of pre-specified input event information), and determine the ID information corresponding to an input event of the user. If it is determined that the ID information corresponding to the input event of the user is ID 2, the intelligent device directly acquires, at the driver layer and from the memory 2 according to the determined ID 2 information, PCM data obtained after the media file corresponding to the input event of the user is decoded. Further, the intelligent device completes, at the driver layer, initialization of an audio device, and sends the acquired PCM data to the audio device for playing.

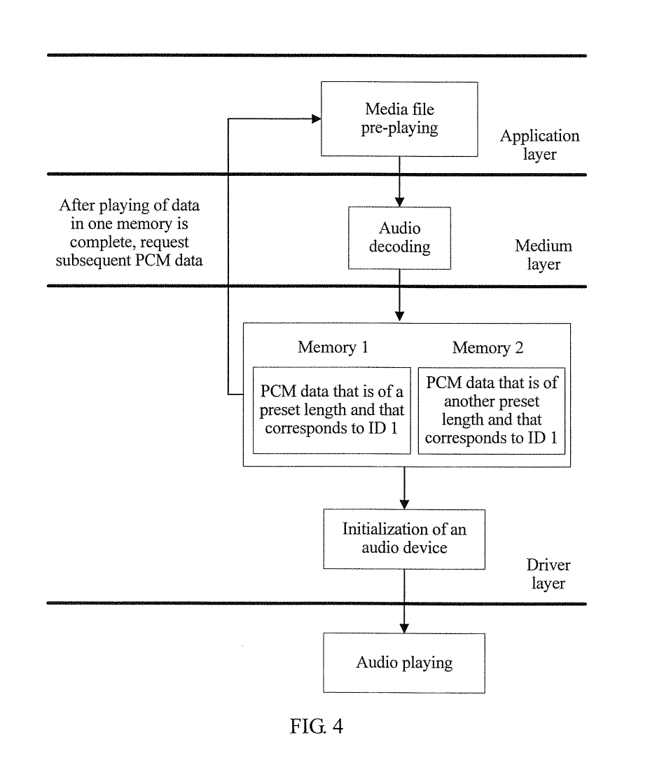

FIG. 4 is a schematic flowchart of Embodiment 3 of a media file processing method according to the present invention. A difference between this embodiment and the embodiment shown in FIG. 3 lies in that a length of a media file in this embodiment is relatively long, and each media file is segmented for decoding and storing. As shown in FIG. 4, in this embodiment, an example of corresponding to an input event is used to describe decoding and storing steps in the media file processing method in detail, where for a specific process of pre-specifying required input event information and ID information corresponding to the input event information, and determining, according to the specified input event information and the corresponding ID information, ID information corresponding to an input event of a user, refer to the embodiment shown in FIG. 3, and detains are not described herein again.

In this embodiment, two memories with a specified length are allocated to one corresponding ID, such as a memory 1 and a memory 2, an intelligent device decodes a first data segment of a preset length (such as a first 1000 ms) of a media file corresponding to the input event information, and stores, in the memory 1, a first PCM data segment of 1000 ms obtained by means of decoding and ID 1 information corresponding to the input event information, decodes a second data segment of a preset length (such as a second 1000 ms) of the media file corresponding to the input event information, and stores, in the memory 2, a second PCM data segment of 1000 ms obtained by means of decoding and the ID 1 information corresponding to the input event information. Further, after playing of the first PCM data segment stored in the memory 1 is complete, a third PCM data segment of 1000 ms is requested, so that the intelligent device decodes a third data segment of 1000 ms of the media file, and stores, in the memory 1, the third PCM data segment of 1000 ms obtained by means of decoding, so as to ensure that there is always decoded PCM data of the media file that is available for playing; meanwhile, the intelligent device plays the second PCM data segment of 1000 ms in the memory 2, and requests a fourth PCM data segment of 1000 ms after playing of the second PCM data segment is complete, so that the intelligent device decodes a fourth data segment of 1000 ms of the media file, and stores, in the memory 2, the fourth PCM data segment of 1000 ms obtained by means of decoding; meanwhile, the intelligent device plays the third PCM data segment of 1000 ms in the memory 1, and cyclically executes the decoding and storing process until the playing of the media file is complete.

At present, all intelligent devices have a capability of displaying a media file (such as an image). However, in the prior art, after receiving an input event of a user, an intelligent device acquires, at an application layer according to the input event, information such as an image resource required for drawing an image and completes image drawing, so as to display the drawn image. Because a drawing process requires a relatively long time, an existing process of displaying a media file is very time-consuming, causing a relatively long delay.

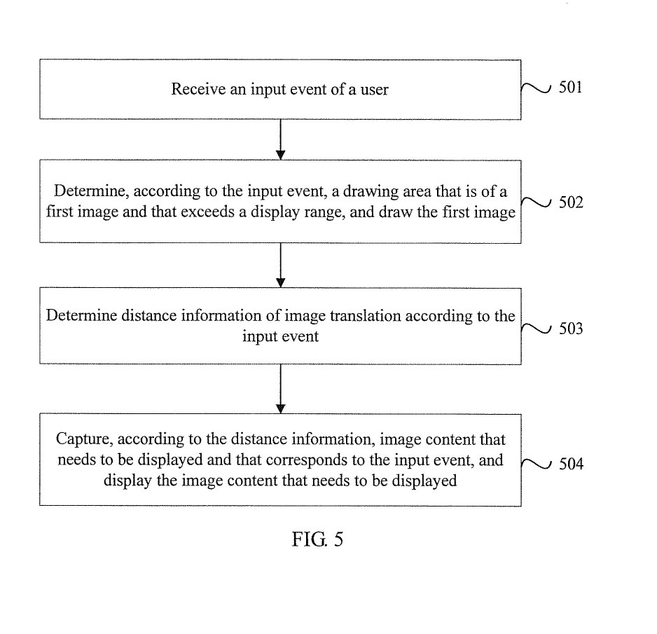

FIG. 5 is a schematic flowchart of Embodiment 4 of a media file processing method according to the present invention. As shown in FIG. 5, the method in this embodiment may include the following steps:

Step 501: Receive an input event of a user.

Step 502: Determine, according to the input event, a drawing area that is of a first image and that exceeds a display range, and draw the first image.

Step 503: Determine distance information of image translation according to the input event.

Step 504: Capture, according to the distance information, image content that needs to be displayed and that corresponds to the input event, and display the image content that needs to be displayed.

An application scenario of this embodiment may be shown in FIG. 1. Details are not described again in this embodiment. This embodiment is executed by an intelligent device, where the intelligent device includes but is not limited to devices such as a smartphone and a tablet computer. In step 501, the intelligent device receives the input event of the user such as key pressing or touchscreen tapping. Optionally, the receiving the input event of the user is implemented in an interrupt receiving manner. Further, at a driver layer, the intelligent device determines the interrupt type and acquires the input event information (information such as coordinates).

In the prior art, first, displacement information needs to be determined; then an image is drawn according to the displacement information; and finally, the drawn image is displayed, where an image drawing operation requires a relatively long time. In contrast, in step 502, first, the intelligent device determines, according to the input event, the drawing area that is of the first image and that exceeds the display range; then pre-draws the first image, so as to quickly display a corresponding image after determining the distance information of the image translation, that is, in this embodiment of the present invention, an image drawing operation requiring a relatively longtime is shifted to a front end of an entire operation procedure of displaying the image; therefore, time from user input to an image display process is dramatically shortened.

Optionally, in step 502, the determining, according to the input event, a drawing area that is of a first image and that exceeds a display range may include: determining, according to coordinate information of the input event, the drawing area that is of the first image and that exceeds the display range.

In this embodiment of the present invention, after the intelligent device receives the input event of the user, the intelligent device may determine, at an application layer according to the coordinate information of the input event, the drawing area that is of the first image, that needs to be updated, and that exceeds the display range. Optionally, coordinates of a tᵢₜₕ moment of the input event are (X1,Y1), coordinates of a tᵢ₊₁_{^{th}} moment are (X2,Y2) (where i is an integer greater than or equal to 0; if total duration of the input event is L, 0≦tᵢ,tᵢ₊₁≦L). The intelligent device can quickly determine an operation direction of the input event (such as upward, downward, leftward, or rightward) according to values of the coordinates, so as to determine the required drawing area that is of the first image, that corresponds to the input event, and that exceeds the display range. Optionally, the drawing area of the first image may be defined as an area that is formed by separately extending along an operation direction and an opposite direction of the input event in a current interface by a preset value. For example, in an SMS application interface, if the input event is a downward sliding operation performed on a screen of a mobile phone by a finger, the mobile phone may determine, at the application layer, that the drawing area that is of the first image and that exceeds the display range is an area formed by separately extending along an upward direction and a downward direction of the current interface by 50%.

Optionally, in step 502, the determining, according to the input event, a drawing area that is of a first image and that exceeds a display range may further include: determining, according to coordinate information and rate information that are of the input event, the drawing area that is of the first image and that exceeds the display range.

In this embodiment of the present invention, after the intelligent device receives the input event of the user, the intelligent device may further determine, at an application layer according to coordinate information and rate information that are of the input event, the drawing area that is of the first image and that exceeds the display range. Optionally, the intelligent device may quickly determine an operation direction of the input event according to the coordinate information. Optionally, if a rate of the input event is greater than a preset value, it can be determined that only an image area along the operation direction of the input event needs to be pre-drawn for the input event. For example, in an SMS application interface, if the input event is a downward sliding operation performed on a screen of a mobile phone by a finger, and a rate of the downward sliding operation is greater than a preset value (quick downward sliding), the mobile phone may determine that the drawing area that is of the first image and that exceeds the display range is an area formed by extending along a downward direction of the current interface by 80% without a need to draw an area formed by extending along an upward direction of the current interface by 50%, thereby saving more time. The intelligent device may quickly calculate the rate information of the input event according to the coordinates (X1,Y1) of the tᵢₜₕ moment of the input event, the coordinates (X2,Y2) of the tᵢ₊₁ₜₕ moment, and a difference between the two moments.

Optionally, in step 502, the drawing the first image may include: acquiring an image resource required for drawing the first image; and drawing the first image according to the image resource and the drawing area of the first image.

In this embodiment of the present invention, the intelligent device acquires, from a file system of the intelligent device, the image resource required for drawing the first image; and then pre-draws the first image according to the drawing area of the first image and the image resource.

Optionally, step 503 may include: obtaining coordinate displacement information of the input event according to start coordinates and termination coordinates of the input event; and determining the distance information of the image translation according to the coordinate displacement information.

In this embodiment of the present invention, the intelligent device obtains, by means of calculation at the intermediate layer according to the start coordinates and the termination coordinates of the input event, the coordinate displacement information of the input event. For example, start coordinates at which the finger slides on the screen of the mobile phone are (X1,Y1), and termination coordinates of the sliding are (X2,Y2), and coordinate displacement information of the finger sliding event may be obtained by taking difference between the start coordinates and the termination coordinates, such as a value of X direction translation and a value of Y direction translation. Further, the intelligent device can determine, at the intermediate layer according to the coordinate displacement information, distance information required for image translation (the coordinate displacement value and the distance value are in a ratio of 1:1). If the finger slides downwards by 1 centimeter (cm), a corresponding image also needs to be translated downwards by 1 cm. Preferably, in this embodiment of the present invention, step 502 and step 503 may be performed simultaneously, which can dramatically shorten display delay time in an image display process.

Further, in step 504, the intelligent device directly captures, at the intermediate layer and from the pre-drawn first image according to the distance information required for image translation, the image content that needs to be displayed and that corresponds to the input event. Optionally, layer overlapping and rendering processing may further be performed on the image that needs to be displayed, and then the image that needs to be displayed and on which layer overlapping and rendering processing are performed is sent at the driver layer by using a bus to a display device (such as an LCD device) of the intelligent device, so as to display the image content. Optionally, in this embodiment of the present invention, the input event may be a complete input event, or may be a part of the complete input event. If the input event is a part (such as a first part) of the complete input event, further, coordinate information of the input event (which is a second part of the complete input event) is acquired, and the foregoing steps 501-504 in this embodiment of the present invention are repeated until the user stops the input event.

Optionally, before the determining, according to the input event, a drawing area that is of a first image and that exceeds a display range, the method further includes: acquiring the coordinate information of the input event.

In this embodiment of the present invention, in a process in which a finger moves on a screen, a terminal device can periodically detect current coordinate information of the finger, so as to acquire the coordinate information of the input event.

In this embodiment of the present invention, first, an input event of a user is received, a drawing area that is of a first image and that exceeds a display range is determined according to the input event, and the first image is drawn; then distance information of image translation is determined according to the input event; and finally, image content that needs to be displayed and that corresponds to the input event is captured from the first image according to the distance information, and the image content that needs to be displayed is displayed, so that it implements that an image drawing operation requiring a relatively long time is shifted to a front end of an entire operation procedure of displaying an image. Therefore, interval time from user input to image display is dramatically shortened and display efficiency of the intelligent device is improved.

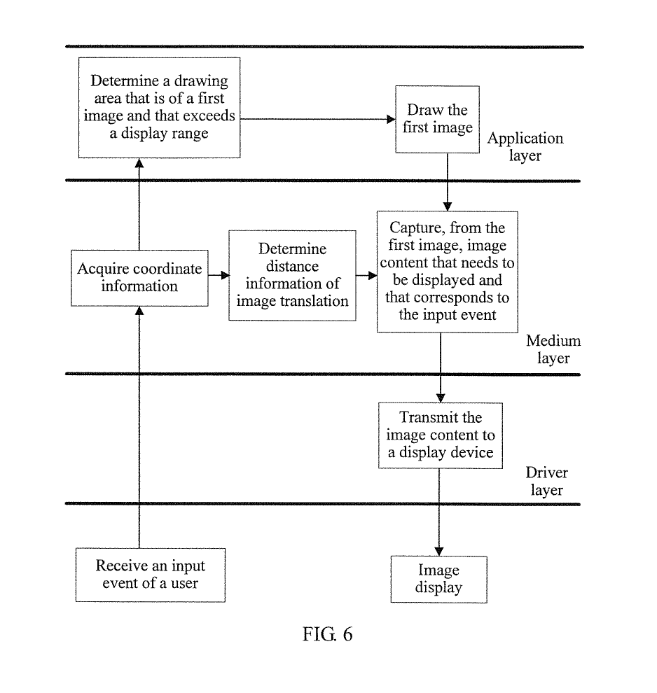

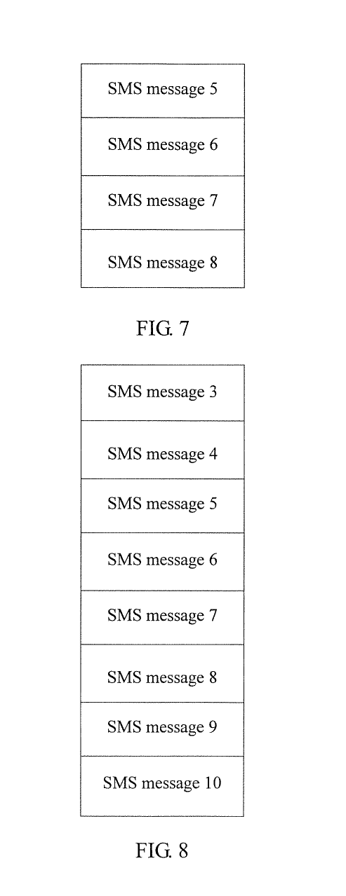

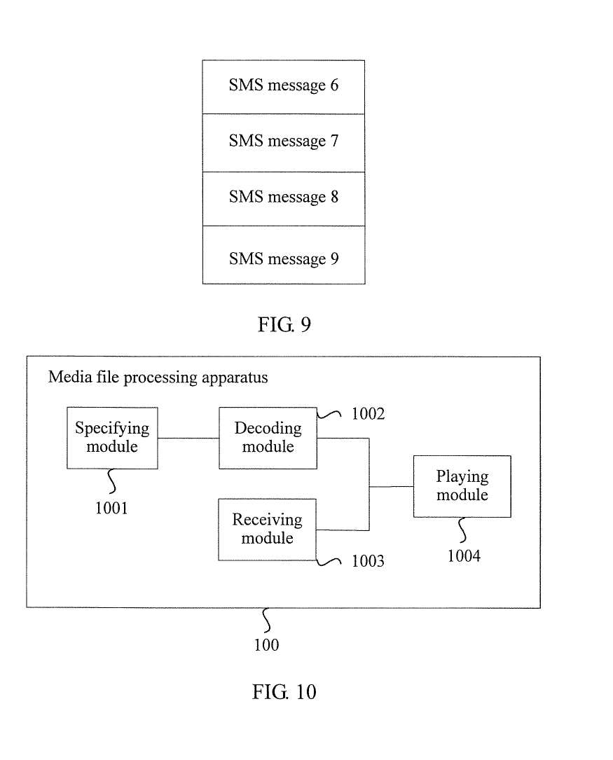

FIG. 6 is a schematic flowchart of Embodiment 5 of a media file processing method according to the present invention. FIG. 7 is a diagram of a current interface in Embodiment 5 of a media file processing method according to the present invention. FIG. 8 is a diagram of a first image in Embodiment 5 of a media file processing method according to the present invention. FIG. 9 is a diagram of a finally displayed image in Embodiment 5 of a media file processing method according to the present invention. In this embodiment of the present invention, an example of displaying an SMS message is used to describe the media file processing method in detail. As shown in FIG. 6, after an intelligent device receives an input event of a user, for example, downward sliding by a finger in an SMS interface shown in FIG. 7, optionally, the intelligent device may acquire the input event information (such as coordinate information) at the driver layer. Further, the intelligent device may determine, at an application layer according to coordinate information and rate information that are of the input event, a drawing area that is of a first image and that exceeds a display range, for example, an area formed by separately extending along an upward direction and a downward direction of a current interface by 50%. Further, the intelligent device acquires, from a file system of the intelligent device, an image resource required for drawing the first image, and pre-draws the first image shown in FIG. 8. The intelligent device obtains, at a intermediate layer according to start coordinates and termination coordinates of the finger sliding event, coordinate displacement information of the finger sliding event; and then determines, according to the coordinate displacement information, distance information required for image translation for the finger sliding event. Further, the intelligent device directly captures, at the intermediate layer and from the pre-drawn first image according to the distance information required for image translation, image content that needs to be displayed and that corresponds to the finger sliding event, and transmits the image content to a display device, so as to display the image content that needs to be displayed. As shown in FIG. 9, the foregoing steps are repeated until the user stops a finger sliding operation.

FIG. 10 is a schematic structural diagram of Embodiment 1 of a media file processing apparatus according to the present invention. A media file processing apparatus 100 provided in this embodiment may be disposed in an intelligent device. As shown in FIG. 10, the media file processing apparatus 100 provided in this embodiment includes: a specifying module 1001, a decoding module 1002, a receiving module 1003, and a playing module 1004.

The specifying module 1001 is configured to specify input event information and identification ID information corresponding to the input event information.

The decoding module 1002 is configured to decode data of a preset length in a media file corresponding to the input event information, and store, in a specified memory, pulse code modulation PCM data obtained by means of decoding and ID information corresponding to the media file, where the ID information corresponding to the media file is consistent with the ID information corresponding to the input event information.

The receiving module 1003 is configured to receive first input event information of a user, and determine first ID information according to the specified input event information and the ID information corresponding to the input event information, where the first input event information is any piece of information in the specified input event information, and the first ID information is ID information that corresponds to the first input event information and that is in the ID information corresponding to the specified input event information.

The playing module 1004 is configured to acquire, from the memory according to the first ID information, first PCM data corresponding to the first ID information, and play the first PCM data, where the first PCM data is PCM data obtained after the data of the preset length in the media file corresponding to the first input event information is decoded.

Optionally, the decoding module 1002 is specifically configured to: decode the data of the preset length in the media file corresponding to the input event information, and store, in a first memory, the PCM data obtained by means of decoding and the ID information corresponding to the media file.

Optionally, the playing module 1004 is specifically configured to: acquire, according to the first ID information, the first PCM data from the first memory, and play the first PCM data.

Optionally, the decoding module 1002 includes:

a first decoding unit, configured to decode a first data segment of a preset length of the media file corresponding to the input event information, and store, in a second memory, a first PCM data segment obtained by means of decoding and the ID information corresponding to the media file; and

a second decoding unit, configured to decode a second data segment of a preset length of the media file corresponding to the input event information, and store, in a third memory, a second PCM data segment obtained by means of decoding and the ID information corresponding to the media file, where the first data segment of the preset length and the second data segment of the preset length are continuous in terms of a time sequence, the first PCM data segment is a first data segment of the first PCM data, and the second PCM data segment is a second data segment that is continuous with the first PCM data segment in terms of time and that is in the first PCM data.

Optionally, the playing module 1004 includes:

a first acquiring unit, configured to acquire, according to the first ID information, the first PCM data segment from the second memory;

a second acquiring unit, configured to acquire, according to the first ID information, the second PCM data segment from the third memory;

a first playing unit, configured to play the first PCM data segment; and

a second playing unit, configured to play the second PCM data segment.

Optionally, the first decoding unit is further configured to: decode a third data segment of a preset length of the media file corresponding to the input event information, and store, in the second memory, a third PCM data segment obtained by means of decoding and the ID information corresponding to the media file, where the second data segment of the preset length and the third data segment of the preset length are continuous in terms of a time sequence, and the third PCM data segment is a third data segment that is continuous with the second PCM data segment in terms of time and that is in the first PCM data.

The first acquiring unit is further configured to acquire, according to the first ID information, the third PCM data segment from the second memory.

Optionally, the second decoding unit is further configured to: decode a fourth data segment of a preset length of the media file corresponding to the input event information, and store, in the third memory, a fourth PCM data segment obtained by means of decoding and the ID information corresponding to the media file, where the third data segment of the preset length and the fourth data segment of the preset length are continuous in terms of a time sequence, and the fourth PCM data segment is a fourth data segment that is continuous with the third PCM data segment in terms of time and that is in the first PCM data.

The second acquiring unit is further configured to acquire, according to the first ID information, the fourth PCM data segment from the third memory.

The media file processing apparatus in this embodiment may be configured to execute the technical solutions in Embodiment 1 to Embodiment 3 of the media file processing methods of the present invention, and an implementation principle and a technical effect of the technical solutions are similar, which are not described herein again.

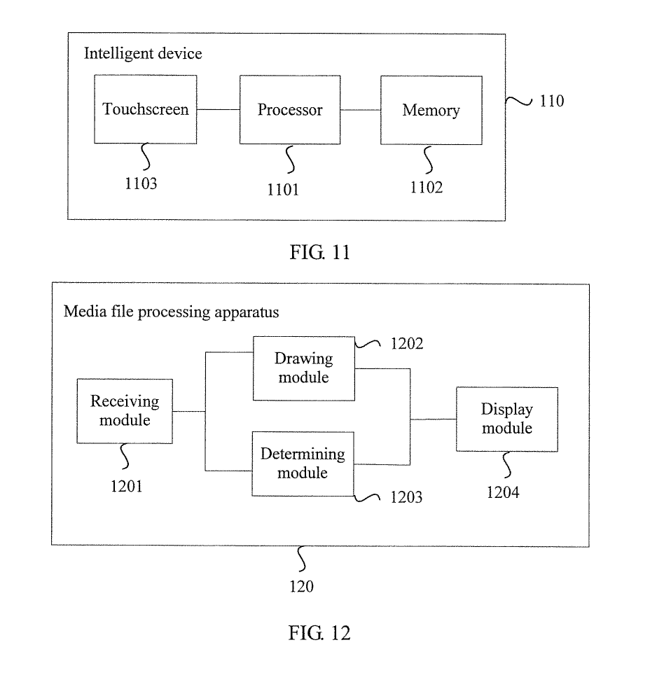

FIG. 11 is a schematic structural diagram of Embodiment 1 of an intelligent device according to the present invention. As shown in FIG. 11, an intelligent device 110 provided in this embodiment includes a processor 1101 and a memory 1102. The intelligent device 110 may further include a touchscreen 1103, where the touchscreen 1103 may be connected to the processor 1101. The touchscreen 1103 is configured to receive an input event and display data, and the memory 1102 is configured to store an execution instruction. When the intelligent device 110 runs, the processor 1101 communicates with the memory 1102, and the processor 1101 invokes the execution instruction in the memory 1102 to execute operations in Embodiment 1 to Embodiment 3 of the foregoing media file processing methods.

The intelligent device in this embodiment may be configured to execute the technical solutions in Embodiment 1 to Embodiment 3 of the foregoing media file processing methods of the present invention, and an implementation principle and a technical effect of the technical solutions are similar, which are not described herein again.

FIG. 12 is a schematic structural diagram of Embodiment 2 of a media file processing apparatus according to the present invention. A media file processing apparatus 120 provided in this embodiment may be disposed in an intelligent device. As shown in FIG. 12, the media file processing apparatus 120 provided in this embodiment includes: a receiving module 1201, a drawing module 1202, a determining module 1203, and a display module 1204.

The receiving module 1201 is configured to receive an input event of a user.

The drawing module 1202 is configured to determine, according to the input event, a drawing area that is of a first image and that exceeds a display range, and draw the first image.

The determining module 1203 is configured to determine distance information of image translation according to the input event.

The display module 1204 is configured to capture, from the first image according to the distance information, image content that needs to be displayed and that corresponds to the input event, and display the image content that needs to be displayed.

Optionally, the drawing module 1202 is specifically configured to determine, according to coordinate information of the input event, the drawing area that is of the first image and that exceeds the display range.

Optionally, the drawing module 1202 is specifically configured to determine, according to coordinate information and rate information that are of the input event, the drawing area that is of the first image and that exceeds the display range.

Optionally, the drawing module 1202 is specifically configured to: acquire an image resource required for drawing the first image; and draw the first image according to the image resource and the drawing area of the first image.

Optionally, the determining module 1203 is specifically configured to: obtain coordinate displacement information of the input event according to start coordinates and termination coordinates of the input event; and determine the distance information of the image translation according to the coordinate displacement information.

Optionally, the media file processing apparatus 120 further includes an acquiring module, configured to acquire the coordinate information of the input event.

The media file processing apparatus in this embodiment may be configured to execute the technical solutions in Embodiment 4 and Embodiment 5 of the media file processing methods of the present invention, and an implementation principle and a technical effect of the technical solutions are similar, which are not described herein again.

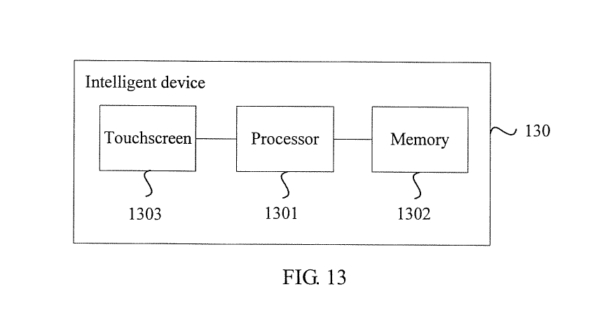

FIG. 13 is a schematic structural diagram of Embodiment 2 of an intelligent device according to the present invention. As shown in FIG. 13, an intelligent device 130 provided in this embodiment includes a processor 1301 and a memory 1302. The intelligent device 130 may further include a touchscreen 1303, where the touchscreen 1303 may be connected to the processor 1301. The touchscreen 1303 is configured to receive an input event and display data, and the memory 1302 is configured to store an execution instruction. When the intelligent device 130 runs, the processor 1301 communicates with the memory 1302, and the processor 1301 invokes the execution instruction in the memory 1302 to execute operations in Embodiment 4 and Embodiment 5 of the foregoing media file processing methods.

The intelligent device in this embodiment may be configured to execute the technical solutions in Embodiment 4 and Embodiment 5 of the foregoing media file processing methods of the present invention, and an implementation principle and a technical effect of the technical solutions are similar, which are not described herein again.

Persons of ordinary skill in the art may understand that all or some of the steps of the method embodiments may be implemented by a program instructing relevant hardware. The program may be stored in a computer-readable storage medium. When the program runs, the steps of the method embodiments are performed. The foregoing storage medium includes: any medium that can store program code, such as a ROM, a RAM, a magnetic disk, or an optical disc.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

1-7. (canceled)

8. A media file processing method, comprising:
receiving an input event of a user;
determining, according to the input event, a drawing area that is of a first image and that exceeds a display range, and drawing the first image;
determining distance information of image translation according to the input event; and
capturing, from the first image according to the distance information, image content that needs to be displayed and that corresponds to the input event, and displaying the image content that needs to be displayed.

9. The method according to claim 8, wherein determining, according to the input event, a drawing area that is of a first image and that exceeds a display range comprises:
determining, according to coordinate information of the input event, the drawing area that is of the first image and that exceeds the display range.

10. The method according to claim 8, wherein determining, according to the input event, a drawing area that is of a first image and that exceeds a display range further comprises:
determining, according to coordinate information and rate information that are of the input event, the drawing area that is of the first image and that exceeds the display range.

11. The method according to claim 8, wherein drawing the first image comprises:
acquiring an image resource required for drawing the first image; and
drawing the first image according to the image resource and the drawing area of the first image.

12. The method according to claim 8, wherein determining distance information of image translation according to the input event comprises:
obtaining coordinate displacement information of the input event according to start coordinates and end coordinates of the input event; and
determining the distance information of the image translation according to the coordinate displacement information.

13. The method according to claim 8, wherein before determining, according to the input event, a drawing area that is of a first image and that exceeds a display range, the method further comprises:
acquiring the coordinate information of the input event.

14-20. (canceled)

21. A media file processing apparatus, comprising:
a receiving module, configured to receive an input event of a user;
a drawing module, configured to determine, according to the input event, a drawing area that is of a first image and that exceeds a display range, and draw the first image;
a determining module, configured to determine distance information of image translation according to the input event; and
a display module, configured to capture, from the first image according to the distance information, image content that needs to be displayed and that corresponds to the input event, and display the image content that needs to be displayed.

22. The apparatus according to claim 21, wherein the drawing module is configured to determine, according to coordinate information of the input event, the drawing area that is of the first image and that exceeds the display range.

23. The apparatus according to claim 21, wherein the drawing module is configured to determine, according to coordinate information and rate information that are of the input event, the drawing area that is of the first image and that exceeds the display range.

24. The apparatus according to claim 21, wherein the drawing module is configured to: acquire an image resource required for drawing the first image; and draw the first image according to the image resource and the drawing area of the first image.

25. The apparatus according to claim 21, wherein the determining module is configured to:
obtain coordinate displacement information of the input event according to initial coordinates and termination coordinates of the input event; and
determine the distance information of the image translation according to the coordinate displacement information.

26. The apparatus according to claim 21, further comprising:
an acquiring module, configured to acquire the coordinate information of the input event.
